(19) United States
(12) Patent Application Publication
(10) Pub. No.: US 2016/0293216 A1
(43) Pub. Date: Oct. 6, 2016

(54) SYSTEM AND METHOD FOR HYBRID SOFTWARE-AS-A-SERVICE VIDEO EDITING

(71) Applicant: BELLEVUE INVESTMENTS GmbH & Co. KGaA, Berlin (DE)

(72) Inventors: Titus Tost, Dresden (DE); Tilman Herberger, Dresden (DE)

(21) Appl. No.: 15/085,754

(22) Filed: Mar. 30, 2016

Related U.S. Application Data
(60) Provisional application No. 62/140,073, filed on Mar. 30, 2015.

(51) Int. Cl. G11B 27/036; G11B 27/06; H04L 12/24; G11B 27/34; H04L 29/06; H04L 29/08

(52) U.S. Cl. CPC G11B 27/036; H04L 65/601; H04L 67/02; H04L 67/06; H04L 41/20; H04L 67/42; H04L 67/10; G11B 27/34; G11B 27/06

(57) ABSTRACT

According to a preferred aspect of the instant invention, there is provided a system and method for hybrid Software-as-a-Service multimedia editing, allowing a plurality of users to utilize Software-as-a-Service video editing on a server with a particular software module installed on client devices that provides a plurality of different functionalities, depending on the individual hardware capabilities and connection capabilities of the client devices, wherein these functionalities are meant to carry the bulk of the hardware intensive processes. The actual editing is carried out in a browser-based graphical user interface provided by a server to each user, therewith decoupling the client devices from the steep hardware requirements associated with video editing and additionally decoupling each user from the confines of a stationary editing place.

This application claims the benefit of U.S. Provisional Patent Application Ser. No. 62/140,073 filed on Mar. 30, 2015 and incorporates said provisional application by reference into this document as if fully set out at this point.

### FIELD OF THE INVENTION

The present invention relates generally to the field of multimedia editing and, more generally, to the field of multimedia editing in an online environment

### BACKGROUND

Software-as-a-Service is no longer just a marketing expression; it has become a reality for some sorts of applications. More and more classical desktop-/client based applications have been replaced by solutions where the user utilizes the full functionality of a client based application from within a generic Internet browser application instead of using a desktop application. In a number of different application areas, Software-as-a-Service solutions have already been successfully established in the market. For example, solutions in desktop publishing, image management and image editing have replaced desktop applications or are experiencing a steady rise in usage percentage.

However, because of the usually high hardware and storage requirements associated with video editing, this particular area of multimedia editing has not been replicated in satisfactory solutions into the Software-as-a-Service ecosystem. The available solutions have proven to be not completely acceptable solutions in terms of usability. This is due, in part, to the general unavailability of the necessary and required infrastructure which has slowly become available in the last few years. However, without an effective, efficient and user oriented approach the availability of infrastructure alone will not be sufficient.

A number of vendors offer video editing in an online environment. However, these solutions tend to reproduce the traditional desktop-editing graphical user interface approach verbatim within the user's Internet browser, which is insufficient and has not provided better accessibility for the user. Of course, this has led to lower acceptance rates as would otherwise be expected and even failure of the provided solutions in the market. Furthermore, these solutions often utilize outdated and potentially unsafe Flash™ based technology or which is similarly reducing the uptake by users, a user, before starting to work, has to install an unreasonable number of plugins leading to either another potential security risk or at least a convoluted procedure which must be followed before finally being able to work with the provided solution.

Modern automatic or template-based video editing within existing solutions offered is only rudimentary integrated at best. Further the problem of large and potentially increasingly larger video file sizes, especially as that impacts uploading of video data to a server, is not handled adequately. With the continuing technological advances in connection with 50p frame rates and 4 k UHD resolution for video material, video files sizes will only get larger, with that particular problem increasing.

What is additionally missing from the currently available software approaches is cross compatibility and cross-linking with existing desktop software solutions. Such compatibility/cross-linking would, of course, permit a user to continue working with online initiated editing projects on a client computer using desktop-based-editing programs and vice versa. The known approaches also do not provide accessible opportunities for a number of users to work collaboratively and simultaneously on the same editing project.

Thus, what is needed is a system and method for video editing that allows a user to edit video material with an Internet browser and share the editing process with other users without having to install desktop-based video editing software. The needed system and method should additionally perform the actual processing of the video material on the server side in a cloud-computing environment. By utilizing and providing cloud-computing based editing the system and method will be able to accommodate multiple users which would be able to do collaborative work on the same video project simultaneously.

Heretofore, as is well known in the media editing industry, there has been a need for an invention to address and solve the above-described problems. Accordingly, it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY OF THE INVENTION

There is provided herein a system and method to provide a hybrid Software-as-a-Service video editing approach.

According to one embodiment, a user will be provided with an option to initiate and utilize video editing from within a generic Internet browser. This approach would make it possible for the user to utilize the system from any location with an Internet connection and independent from the hardware capacities of the user's machine. The user will be able to interact with the graphical user interface to control the video editing process from any arbitrary client device that supports a browser.

In one arrangement, a user will be presented with a hybrid editing solution. Hybrid standing for the intentional delegation of processes connected to video editing to either a server side or the client side—to implement processes either on the server side or the client side, wherein the details of this delegation are not visually communicated to the user. As part of his solution one embodiment provides a software module that is installed locally on the user's client device which might be, by way of example only, a personal computer, a tablet computer or a smart phone. This software module operates in conjunction with the software solution on the server side and also is in constant communication with the server side of the instant invention. In some embodiments it will be distributed to the user when the user connects to the server or in some cases it might be separately installed on the client device. One function of this software module is to support the functionalities executed and provided by the Internet browser-based user interface during the editing process. Simply speaking this module functions as support for certain hardware stressing and time intensive tasks to provide a fluid and efficient editing experience.

One function of the software module is to manage and simplify the transfer of the video source material from the client device and to/from the user and the server computer.

In an approach, a number of different tasks will be provided and carried out by the software module to implement an embodiment of the hybrid Software-as-a-Service video editing solution. According to the current arrangement, the software will prepare, for example, low resolution interim versions of the source material and data files in order to facilitate the quick generation of source video material for editing. In this case, the generated interim version will be smaller in size than the original and will, therefore, be uploaded faster to a server. This will allow the user to more quickly begin to process the input material in the graphical user interface provided by the browser.

Continuing with the current example, the software module will additionally provide, manage and secure the communications with the browser-based editing user interface with the goal of providing the user with a highly responsive user experience. The software module will implement a number of different functions that are intended to achieve this goal. For example, it generates and uploads the low resolution interim video files from the source material, it generates and uploads necessary components (implementing smart-copy algorithms) from the source material, it transfers only those sections of the source material in the highest resolution to the server that are actually needed, it manages the utilization of the processing power of the graphical processing unit available in the client system The software module is preferably available and provided for all the software platforms. The instant invention will implement a mixture of these mentioned tasks, depending on a number of different criteria; such criteria might be, for example, available bandwidth, quality requirements from the user and the individual user's hardware which will be different from device to device. For example, a personal computer usually featuring high processing power compared to other portable computing devices, allows the client software module to potentially utilize more of the previously mentioned functionalities. Whereas, when the user's computer is less capable or if the user is utilizing a table computer or phone, more of the computation will be shifted to the server.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following detailed description and upon reference to the drawings in which:

FIG. 1 depicts the general working environment of the instant invention.

FIG. 2 shows the working environment of the instant invention in more detail.

FIG. 3 illustrates the provided diverse functionality of the client tool.

FIG. 4 illustrates a compressed illustration of the individual parts of the instant invention.

FIG. 5 illustrates one potential workflow of the instant invention.

FIG. 6 illustrates the server-only scenario of the instant invention.

FIG. 7 illustrates the software module (tray) and server scenario of the instant invention.

FIG. 8 illustrates the software module (tray) only scenario of the instant invention.

### DESCRIPTION OF THE PREFERRED EMBODIMENTS

Referring now to the drawings, wherein like reference numerals indicate the same parts throughout the several views, there is provided a preferred system and method for implementing hybrid Software-as-a-Service video editing.

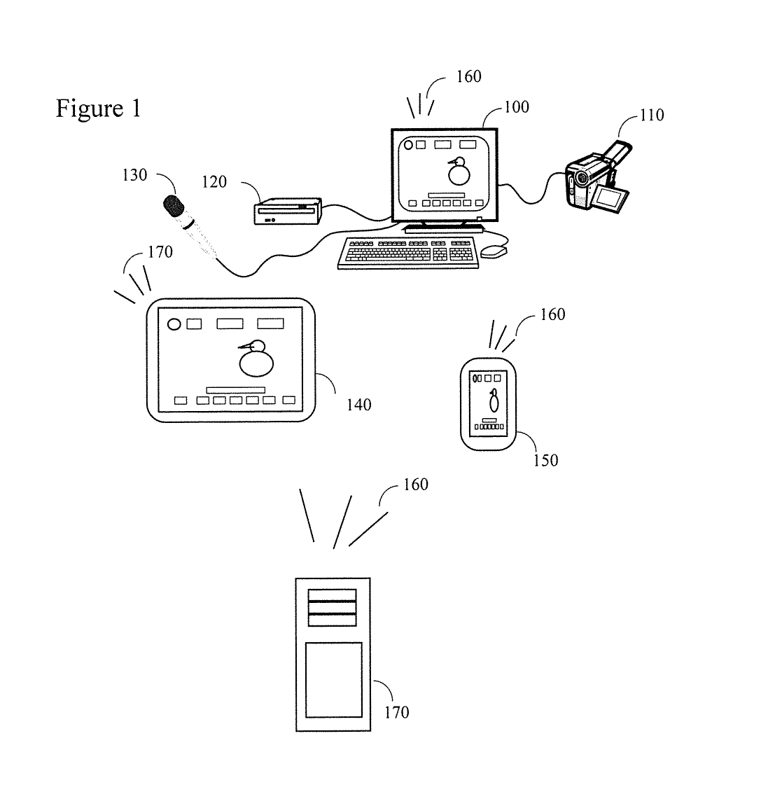

As is generally indicated in FIG. 1, at least a portion of the instant invention will be implemented in form of software running on, for example, a user's personal computer 100, a tablet computer 140, or a mobile phone, preferably a smart phone 150, wherein all of these devices are connected to the Internet, preferably via a wireless connection 160.

As is well known, these different devices have differing hardware capabilities. The instant invention capitalizes this fact. The software module that will be installed on the user's devices will provide and utilize a differing number of functionalities depending on the hardware capabilities of these devices. So the software module as it exists on a personal computer 100 will provide a majority of the functionality of an embodiment, whereas on a tablet computer 140 typically only a smaller subset of the potential range of functions will be provided and on a smart phone 150 a minimal subset or no functions are provided. As part of the functionality of the instant invention all these devices will connect to a server 170 which will provide the graphical user interface containing the editing functionality to a user.

The computer 100 will have some amount of program memory and hard disc storage (whether internal or accessible via a network) as is conventionally utilized by such units. Additionally, it is possible that an external camera 110 of some sort be utilized with—and will preferably be connectible to—the computer so that video and/or graphic information can be transferred to and from the computer. Preferably the camera 110 will be a digital video camera, although that is not a requirement, as it is contemplated that the user might wish to utilize still images from a digital still camera in the creation of his or her multimedia work.

Further given the modern trend toward incorporation of cameras into other electronic components (e.g. in handheld computers, telephones, laptops, etc.) those of ordinary skill in the art will recognize that the camera might be integrated into the computer or some other electronic device and, thus, might not be a traditional single-purposes video or still camera. Although the camera will preferably be digital in nature, any sort of camera might be used, provided that the proper interfacing between it and the computer is utilized. Additionally, a microphone 130 might be utilized so that the user can add voice-over narration to a multimedia work or can control his or her computer via voice-recognition software and additionally a CD or DVD burner 120 could be useful for storing content on writable or rewritable media.

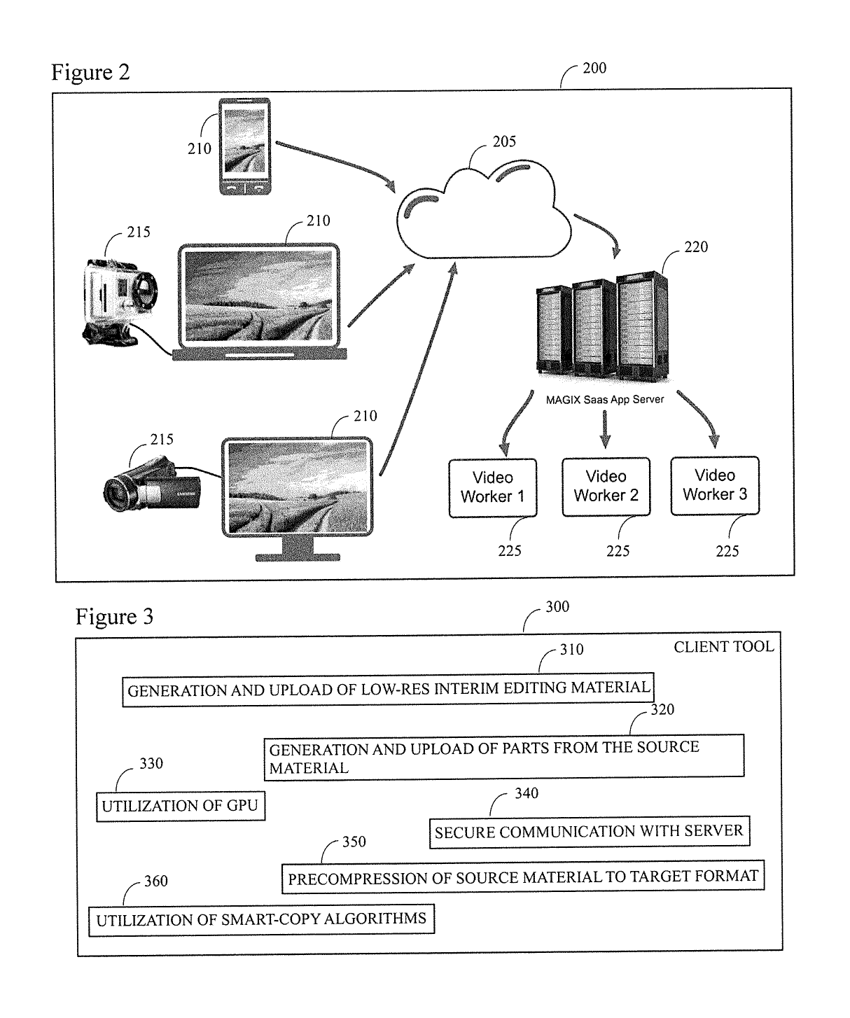

FIG. 2 depicts an illustration of an environment suitable for use with various aspects of the instant invention. In this figure a number of different computing devices 210 are depicted which generally represent the sorts of different hardware devices that could potentially implement an embodiment. In this particular figure a smart phone, a notebook or tablet and a personal computer are depicted, but, of course, the choice of hardware that is depicted in this figure is not intended to limit the application to only these three device types. One of ordinary skill in the art would be well aware that any number of different electronic devices could be utilized in accordance with the teachings herein. Depending on the computing capabilities of these devices various embodiments the instant invention will provide a graduated spectrum of functionalities.

The source material for the workflow is provided by a number of different devices 215, which are illustrated as delivering the material to the computing devices. The source material, which will typically be video material, will either be directly transmitted to a receiving server over the Internet, or the source material might first be stored on a local computing device and, after storage transferred, to the server. Additionally, it should be noted that the differences in functionality between the devices that process the source material and the devices that generate the source material are rapidly disappearing. Tablet devices and smart phones are more than capable of recording and generating video source material. Thus, it should be noted that source material might be generated or made available from a number of different devices and a number of different devices could potentially be used to control the source material editing process.

Continuing with the present example, the computing devices 210 will be connected via the Internet to one or more remote servers 220 that will provide the cloud-based infrastructure, which is generally represented by the cloud symbol 205 in FIG. 2. This embodiment with the illustrated server structure is intended to provide a simultaneous multi-user approach, wherein multiple users are provided with their desired and non-edited and edited video output material simultaneously.

The server computers 220 process the editing instructions provided by the user or users 225 and implement these on the transferred source material, thereafter providing the edited output material to each participating user. The output material might be transferred to one individual user or to a plurality of users, wherein the distribution scheme will also preferably be specified by the user.

Turning next to FIG. 3, this figure illustrates an embodiment of the functionality of the software module 300 that provides the hybrid Software-as-a-Service video editing capability to users of the instant invention. The software module will preferably be installed on the client side, e.g., on the user' personal computer, smart phone or tablet PC if the hardware capability is sufficient to utilize the functionality of instant invention. A desirable, although not required, aspect of certain embodiments is that they will be operable on multiple devices and operating systems and such functionality will be integrated into the operations of the server and client devices.

With respect to the present example, the software module will provide a wide variety of different functionalities that are directed to support and simplify the Software-as-a-Service video editing process. It should be mentioned that not all of these different functionalities need be utilized at the same time and on all devices implementing the software module. However, some of these are more likely to be utilized. The instant invention and primarily the hardware capabilities of the participating client devices determine when to implement the individual functionalities and also what functionalities are implemented.

An important function of the software module will be the generation and uploading of low resolution interim material 310. For purposes of the instant disclosure, this will be referred to as the generation of proxy files, which will be uploaded to the server from the client device instead of the larger original source material. This functionality is designed to reduce the volume of data that must be transferred to the server and, thus, allow the user to begin working on the editing project more quickly, with the unprocessed original full resolution source material being transferred as a background process either afterwards or simultaneously as the bandwidth permits.

Another similar functionality is the generation and uploading of individual parts from the input material 320, the smart-copy approach, wherein the individual parts are selected and determined according to the current editing position. An embodiment monitors the current editing position and provides the input material before and after the current editing position to the user. This will be carried out by following a particular predefined time window that encompasses the point on the timeline where editing is currently taking place, for example a period of three minutes before and after the current editing state might be provisioned by the instant invention. This functionality is also primarily designed to reduce the amount of data that needs to be transferred between the client and the server which makes it possible for the user to begin or continue editing without any substantial period of waiting.

In an embodiment, the server communicates with the client and instructs the software module on the client which parts of the input material are desired at a specific moment in time. This might be accomplished in many ways but one preferred way is to communicate data containing specific time point data values which will be used by the software module to select or generate these desired parts which will then subsequently be uploaded to the server. This operation will be carried out on the client side, preferably in the background so that it does not impact the user's editing experience.

Note that it is certainly possible that a user might have access to and utilize other programs that would assist in the editing and/or effects process. In that case, in some embodiments the server side program could provide the appropriate sections of source material to the external modules, preferably in a low-resolution version.

In addition to the functionality mentioned above, an embodiment will also utilize the processing power of the graphics processing unit 330 contained in the computer on which the software module is installed is such is available. The instant invention will determine whether the associated graphics processing hardware in the client device allows utilization for the processing of input video material, for example for the generation of the interim video files or the determination and generation of the individual parts of the source material. If that is the case the GPU (“graphics processing unit”) processing power of the client will be utilized. Determination of whether or not the GPU of the client device is capable of being utilized will be carried out by either running a benchmark test on the device or by matching the name of the GPU or another identification detail with a list of compatible GPUs. This list might be provided along with the initial provision of the software module and/or via delivery of continuous updates transmitted, for example, via the Internet.

In some embodiments the benchmark might operate as follows. The program that is resident on the client device might determine the hardware capability of the user's computer using a pre-calculated list of popular hardware devices. For example, it might be the case that a user has an iPad® that has been assigned a processing power of between 14 and 20 on depending on the particular model. The numerical value is arbitrary and indicates in a general way the device's hardware capabilities. In such a case, precompression of source material to a selected output format might be possible. On the other hand, and according to the present scale, if the device had processing power of 0 to 3, no processing at all on the device would be possible. A processing power of 4-7 might indicate those devices that were capable of generating low resolution versions of the current editing positions. A processing power of 8 to 11 might be assigned to devices that would be capable of generating low-resolution version of the complete source material. Finally, processing power of 14 to 17 might indicate those devices capable of compressing the output material to a selected format (e.g., if a resolution change is necessary).

The communication and data transfers between the browser-based editing graphical user interface provided by the server and the software module installed on the client device will be handled preferably invisible to the user. Additionally, in some embodiments it will be carried out in a secure fashion utilizing well known and well established technologies, like SLS/TLS 340. Furthermore, the functionality of the software module will typically include the implementation of the mentioned smart-copy algorithms 360, meaning that the communication between the browser-based editing part on the server and the software module and the editing state will be monitored to determine that particular content that is currently being edited and will, with a high probability, be edited in the future. The software module generates these particular content sections and provides these sections to the server which processes these sections according to the instructions from each user.

One of the functions of an embodiment is to keep the waiting periods for the user at the beginning and during the editing process as low as possible. The software module additionally provides a pre-compression of video material to a target format with a particular target resolution 350 that has been defined by the user in the browser-based editing graphical user interface. Pre-compression in this particular context means that the software module will compress the input material to the desired target resolution and provide it for use during the upload process. For example, suppose the user edits a section with a length of 2 minutes and has already selected an output format. This embodiment will then compress the input material—not including the currently edited section—to the selected output format and upload the compressed material to the server. On the server, after the user finishes editing the video work, the edited section will be combined with the uploaded material.

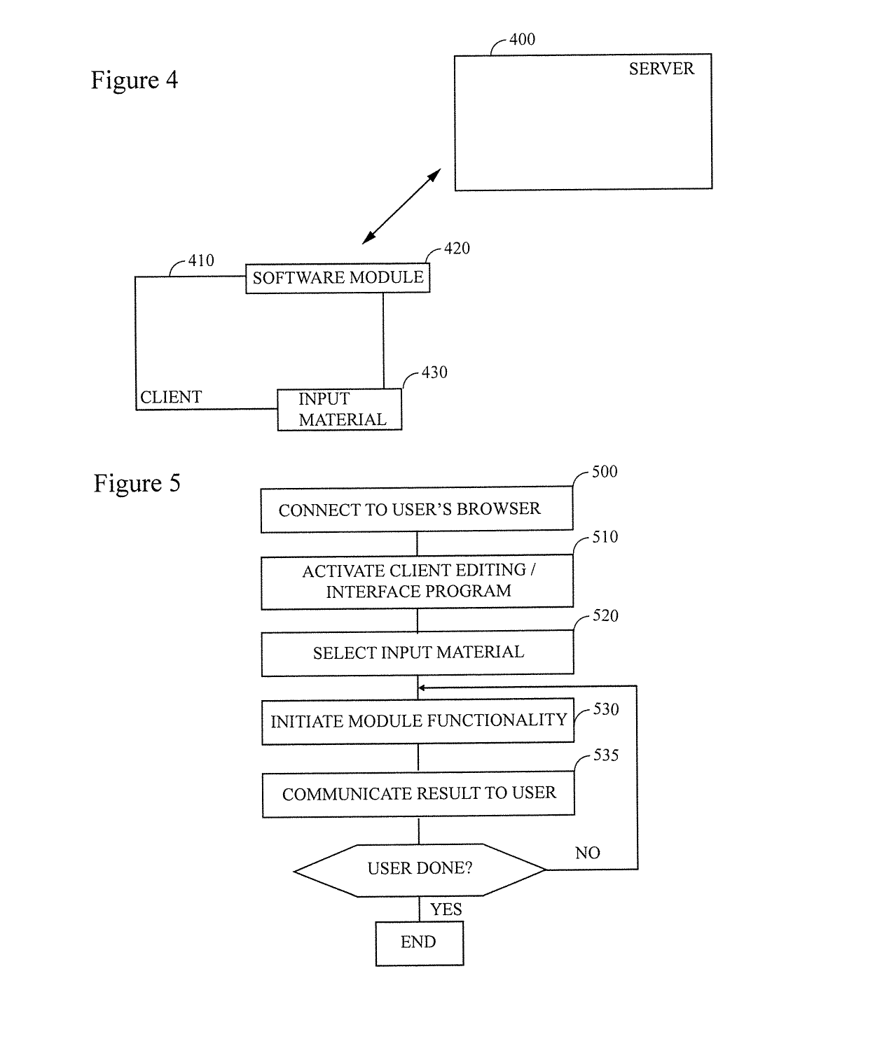

Turning next to FIG. 4, this figure illustrates the layout of some of the main parts of an embodiment. The main components are the server 400 and the client 410. The server will provide the data and software necessary to implement the browser-based editing graphical user interface on the user's computer. It further will manage the identification of user interaction (e.g., via a login) and the responding to the selections made by the user in the graphical user interface. It will additionally be responsible for processing the video data as directed by the user, the instructional editing data as well as the editing material itself. The user on the client device 410 will control the operations of the graphical user interface and therewith the whole video editing process.

The user will provide the source material 430 which will be transferred from the client device to the server. This transfer will preferably be implemented in one of a variety of ways depending on the hardware capabilities of the participating and initiating client device. The source material might be video files already stored on the client device, or video material captured by the client device and subsequently edited by the user. In some embodiments the source material will consist of digital images.

Continuing with the current example, the software module 420 by analyzing editing instructions initiated and transmitted from the user will control the different functionalities of the software module to ensure the user a smooth and fluid editing process and also ensure a similar experience for all participating users in a multi-user environment. It should be noted that although the specification primarily speaks about a single user, the instant invention is flexible enough to permit a multi user approach, wherein more than one user is able to communicate and utilize the instant system simultaneously. Additionally, in this embodiment the server side provides a multi user approach that permits editing the same source material by multiple users. In this case, the server provides the uploaded material to multiple participating users as soon as it is received from the initiating user. By providing editing decision lists from the server to interested users this embodiment also provides the users the opportunity to continue editing the source material in a video editing software program installed locally on the user's client device. The editing decisions lists contain all edit instructions entered by participating users and also contain the instructions necessary for the software editing program to access the source material.

FIG. 5 depicts one example of a streamlined workflow of an embodiment that illustrates the main steps. In a first preferred step the user will connect the browser with the browser-based graphical user interface for video editing 500 wherein the server provides all the necessary data for the graphical user interface. Regarding the next steps depicted in this figure it should be mentioned that the instant invention is not restricted by requiring that the steps in the figure proceed sequentially. In various embodiments the steps could be performed in any order, and/or simultaneously (if appropriate) or one after another, etc. The mentioned steps will be initiated automatically repeatedly, simultaneously and interchangeably, during the whole video editing process and it will only be limited by the capabilities of the hardware of the client devices. At least an intermittent connection with the remote server hardware via the browser based graphical user interface is required to allow data and/or commands to be transmitted back and forth.

Continuing with the example of FIG. 5, the user will initiate the editing process 510 e.g., by connecting to the server provided graphical user interface on the client device and by selecting the input material 520. The functionality of the software module will be activated automatically 530 when the user establishes the connection to the browser and the software module is from that moment in communication with it. Another process that will also be running on the client device is a routine that monitors the user interaction with the browser-based graphical editing user interface that is displayed locally on the client computer.

With respect to the present example, these processes will continue to run until the user or users decide to end the editing process 550. These general steps will typically be the same for all participating users and the number of the participating users is only limited by the processing power of the server side of the instant invention.

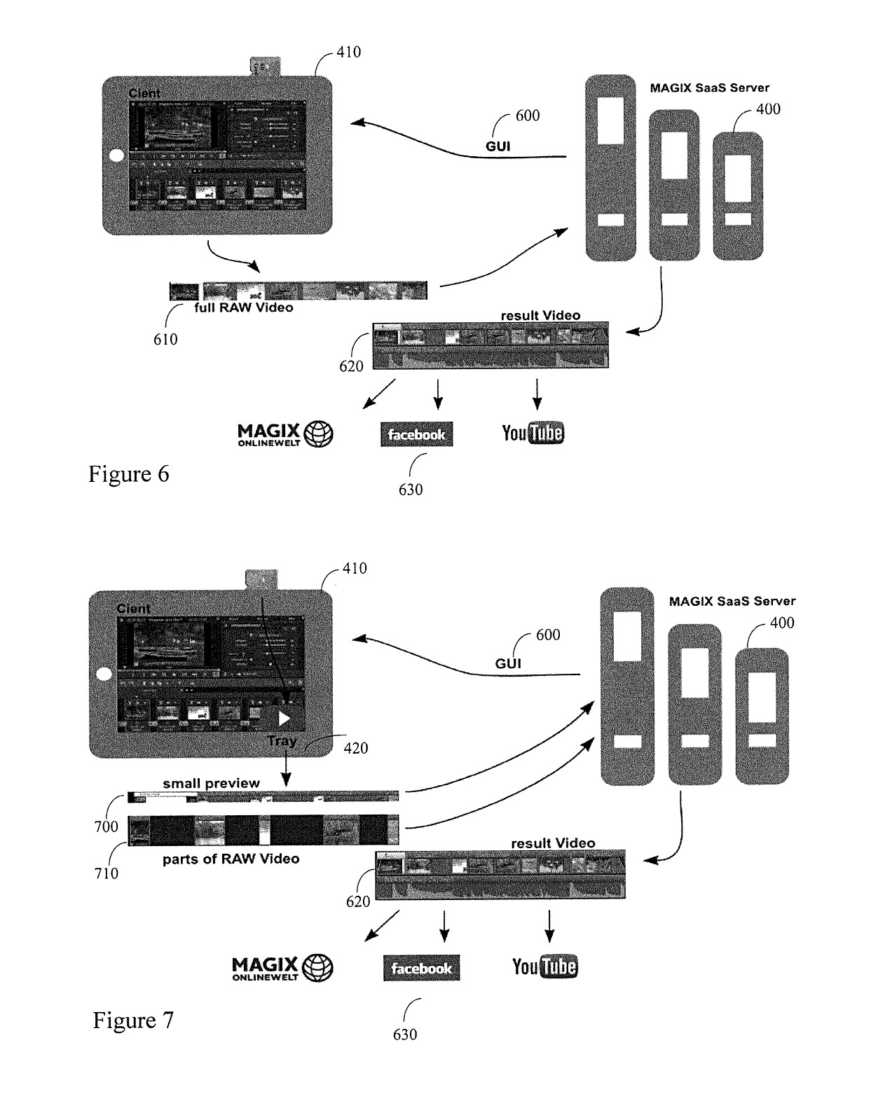

Turning next to FIG. 6, this figure depicts a server only embodiment. This scenario provides the classic Software-as-a-Service approach, without the support of a local software module. This scenario would be applicable to, for example, smartphones, inexpensive tablet devices with slow processors, or for personal computers without any particular rights to install software programs (e.g., personal computers situated in internet-cafes or offices). In this scenario the client device 410 communicates directly with the server 400, which provides the graphical user interface to the user 600 and any particular source material 610 that needs to be uploaded before the start of the editing process. The resulting video 620 will, in this embodiment, be available for distribution via available online venues 630.

Coming next to FIG. 7, this figure illustrates an embodiment of a software module (tray) and server scenario of the instant invention. This scenario could be utilized on client devices 410 that support the installation of the software module (tray) 420 and that additionally provide sufficient processing capacity to process at least some video material locally, for example scaling and cutting video source material. In this particular scenario low resolution video streams 700 will be generated locally, for example by using fast hardware codecs. The generated video streams will then be transferred to the server and used for editing. Afterwards only the sections of the high resolution source video material 710 that are needed in the generation of the output material will be uploaded to the servers 400. This particular scenario provides the hybrid processing approach in its purest form, wherein the workload between local device 410 and server 400 is divided in the interest of an optimal user experience. Suitable devices that might be used with this embodiment are high performance tablet devices, portable computers and personal computers that allow software to be installed and run locally. In this variation, the server 400 provides the graphical user interface to the user 600 wherein the resulting video 620 is being provided by the server for distribution over available online venues 630 to the user.

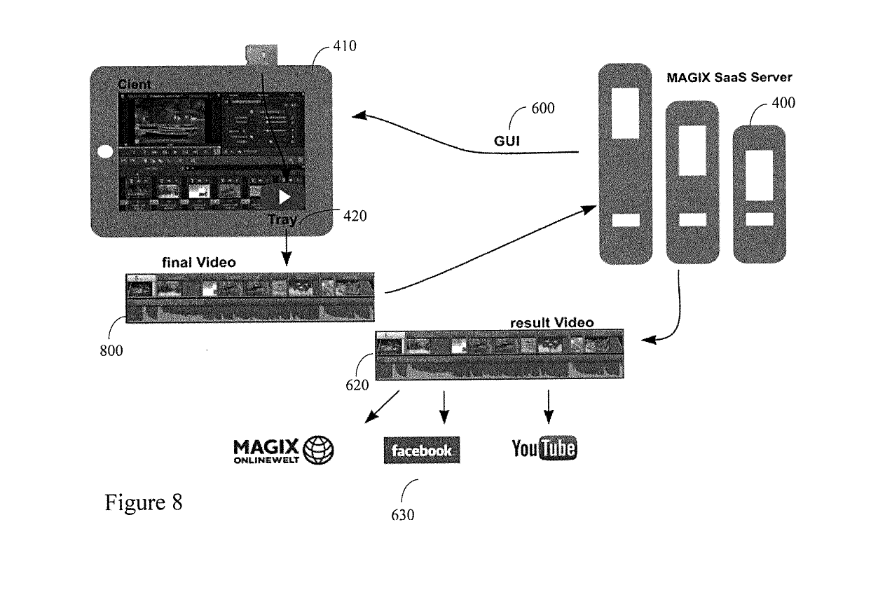

Turning next to FIG. 8, this figure illustrates the software module 420 (tray) online scenario. In this scenario the client device 410 with the installed software module 420 bear the complete video processing process load, only the graphical user interface 600 remains in the browser which is provided by the server 400. In contrast to traditional video editing with a personal computer, the user will avoid having to wait on editing computations that are handled by low-performance hardware and spared from acquiring the storage that would otherwise be necessary if a video editing program was run locally.

As a specific example of an embodiment, consider the following scenario where a user wishes to perform the following operations on a video work using a tablet computer such as an Apple iPad® which has 12 minutes of 1920 by 1080p video (VIDEO 1) stored locally on it:
(1) Add titles to the start and credits to the end of the video;
(2) Cut a two-minute segment from VIDEO 1 at 6 minutes into the video;
(3) Insert a transition where the video was cut;
(4) Color correct the remaining video to remove the color cast because of fluorescent lighting;
(5) Insert a still image into the video;
(6) Insert one minute of another video (VIDEO 2) at 3 minutes into to VIDEO 1. This video is 800 by 600 and is stored on the user's table computer;
(7) Add background music to the entire video using an audio file stored on the tablet computer; and,
(8) Publish the edited video to an online video-sharing site such as YouTube®.

In practice the user will utilize one particular embodiment generally as follows to accomplish this series of tasks. Note that in the example that follows the identifiers PROGRAM 1 and PROGRAM 2 will be used to help differentiate the tasks performed by the server and client, respectively. That being said, nothing in the example below should be interpreted to require that only two programs might be involved in this method since, as is well known to those of ordinary skilled in the art, it is common to utilize multiple programs to perform a requested operation.
a. The user will use navigate to a website hosted by the server using a browser on the tablet computer.
b. The user will select a website option to activate the program which is the core web-based editing program (PROGRAM 1) that is running on the server. According to the current example, in FIG. 7 the GUI 600 and item 410 represent PROGRAM 1.
c. PROGRAM 2 (which is the software running on the table computer and which is in constant contact with PROGRAM 1 in the background) will automatically run a CPU benchmark on the user's iPad® and send the results to PROGRAM 1 on the server. According to the current example, item 420 corresponds to PROGRAM 2.
d. The results of the benchmark will be used internally to determine which operations can be performed on the user's computer and which would better be performed on the server.
e. The user will interact with PROGRAM 1 to select VIDEO 1 and PROGRAM 2, in an effort to make it available for editing as quickly as possible, will begin downsizing it.
f. PROGRAM 1 will display the timeline of VIDEO 1 to the user.
g. The user interacts with PROGRAM 1 to move the timeline edit point to 6 minutes.
h. PROGRAM 2 will (if such is not already available) generate a lower resolution video (e.g., 800 by 600) that includes the edit point and some additional time either side of it. In the current example, it might begin at say, 5 minutes and end at say, 9 minutes. The lower resolution video will automatically be sent to the server where it will be received by PROGRAM 1.
i. PROGRAM 2 will continue to downsize the entirety of VIDEO 1 and transmit it to the server in background. As soon as that is done, the high-resolution version of VIDEO 1 will be transmitted to the server in background.
j. The user will cut one minute from VIDEO 1. PROGRAM 1 will execute the cut on the server sending PROGRAM 2 the information about the cut video. PROGRAM 2 will incorporate that information in such a way that the cut minute from VIDEO 1 is no longer part of any pre-processing functionalities, therewith in a way PROGRAM 2 is also cutting the minute from VIDEO 1, but in a general sense it puts it on a “do not use” list. PROGRAM 1 will transmit the instruction to an editing list file containing all user instructions. This will make it possible for the edits to be nondestructive and reversible (e.g., via an “undo”—type command).
k. Next the user will insert a transition at the spot where the video material was cut.

PROGRAM 1 will present various video transition options to the user and, depending on the transition selected, it might be performed locally (e.g., a “fade to black” transition) or on the server via PROGRAM 1 (e.g., where the last frame ahead of the cut is spiraled down to a point and the spiraled up again to reveal the first frame after the cut). In either case, the instruction that defines the transition will be stored on in the edit list on the server.
l. The user will next select using PROGRAM 1 the option to color correct the video to remove the color introduced by fluorescent lighting. PROGRAM 1 will transmit and store the edit request in an editing list file on the server and it will then be executed on the low resolution copy of VIDEO 1 on the server. The same will be done on the full resolution version that is resident on the server as soon as this version is available.
m. The color corrected low-resolution version of VIDEO I will be transmitted back for display on the user's tablet.
n. Next, the user will from within PROGRAM 1 select a still image that is resident on the user's tablet for insertion into VIDEO 1 and position the edit point at the location where the image is to be inserted.
o. PROGRAM 2 will, depending on the format of the still image, generate a lower resolution version of the image which will be transmitted to transmitted to the server for integration into the low resolution version of VIDEO 1 which will then be transmitted back for display on the user's tablet. The full resolution image will also be transmitted (in background) to the server where it will be inserted into VIDEO 1. The insertion point, file name, and length of time the still image is to be displayed will be transmitted into the editing list file containing all user instructions collected by PROGRAM 1
p. Next, user will select VIDEO 2. PROGRAM 2 will determine if low-resolution version is necessary. In this particular example, 800×600 is already low resolution and matches the resolution of the low-resolution version of VIDEO 1, so no format change would be necessary. VIDEO 2 will be uploaded in the background to the server.
q. On the tablet computer, the user will move the edit point to 3 minutes into VIDEO 1, and indicate an insertion of VIDEO 2 is to take place. PROGRAM 1 will receive that instruction and incorporate VIDEO 2 into the low resolution version of VIDEO 1 and up-convert VIDEO 2 to match the resolution of VIDEO 1. The edit instructions will also be stored in the editing list file.
r. The user will next select from within PROGRAM 1 an audio file that is resident on the user's tablet that is to be added as background music for the edited VIDEO 1. The audio file will be transmitted to the server where PROGRAM 1 will add it as background audio to the edited version of VIDEO 1 as well as the high-resolution version. The editing instruction will also be stored in the editing list file. If the selected audio is of an audio quality or format (FLAC for example) that also requires a high bandwidth capability, PROGRAM 2 might also be able to convert it into a lower quality version, for example mp3 for transmission to PROGRAM 1.
s. Finally, the user will select the option of publishing the video to YouTube®. PROGRAM 1 will read the editing list file and implement those instructions into VIDEO 1 to generate OUTPUT VIDEO 1 which will then be published to YouTube® as requested by the user. Methods of transmitting videos to sharing sites such as YouTube® are well known to those of ordinary skill in the art.

That the foregoing is a simplified example of what might happen in practice during an editing session and has been illustrated as a step by step process to clarify the division of labor between the client and server for one specific example. In other instances, PROGRAM 1 might, instead of writing the instructions to the editing list file, simply execute the instructions upon receipt. That would speed up the process of uploading the video (e.g., to YouTube®) since otherwise all of the edits performed by the user would be held and executed only when the user indicated that editing was completed.

Additionally, note that in the foregoing the client provides the data, and one goal of this embodiment is to help the user edit even very large video files using a computing device with restricted CPU capacity. The server will aggregate the user instructions, working like a “normal” video editing solution and implementing the instructions to generate the output material.

In summary, the instant invention provides a highly creative work method for multiple users when editing source material independent of a stationary computer. The instant invention decouples editing from the well-known confines and provides the user a way to dynamically edit multimedia material collaboratively over the internet, wherein a software module is provided on the client side that monitors the editing process and supports a fluent editing by initiating a plurality of different functionalities depending on the user's hardware.

### CONCLUSIONS

Of course, many modifications and extensions could be made to the instant invention by those of ordinary skill in the art. For example in one preferred embodiment the instant invention will provide an automatic user profile based multimedia editing approach, wherein for each user the personal client devices are stored in a profile on the server containing information about the functionalities of these client devices and also containing information about the technical requirements of each individual client device and wherein the instant invention automatically synchronizes the recorded multimedia material on these client devices with the server, wherein this synchronization comprises of an automatic preprocessing of the multimedia material as soon as it is stored on each client device to further fasten the editing process.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed or limited to there being only one of that element unless the context specifically indicates otherwise.

Where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention Cis not limited to those diagrams or to the corresponding descriptions. For example, flow need not move through each illustrated box or state, or in exactly the same order as illustrated and described.

Unless indicated otherwise, methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners□of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)—(a second number)”, this should be interpreted to mean a range of numerical values where the lower limit is the first number and the upper limit is the second number. For example, 25 to 100 should be interpreted to mean a range with a lower limit of 25 and an upper limit of 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A method of hybrid video editing, wherein is provided a client computing device containing a client video work, and a server remote from the client computing device, comprising the steps of:
a. accessing the server from the client computing device using an Internet browser;
b. within said browser, selecting the client video work having a client video resolution;
c. within said browser, selecting a video editing operation;
d. creating a low resolution version of at least a portion of said video work, wherein said low resolution version of said at least a portion of said video work is at a lower resolution than said client video resolution;
e. transmitting the low resolution version of said at least a portion of said video work from the client computing device to the server;
f. transmitting the video work from the client device to the server;
g. on the server, performing said video editing operation on said low resolution version of said video work, thereby creating an edited low resolution video work;
h. on the server, performing said video editing operation on said video work, thereby creating an edited video work;
i. displaying within said browser at least a portion of said edited low resolution video work on the client computing device; and, performing steps (c) through (i) at least twice, thereby creating a hybrid video version of said client video work.

2. The method according to claim 1, wherein said client video editing operation is selected from the group consisting of a transition, a video cut, an insertion of a still photo into said video work, an insertion of a second video work into said video work, and, a color correction of said video work.

3. The method according to claim 1, further comprising the step of:
k. displaying within said browser at least a portion of said hybrid video edited version of said client video work on said client device.

4. The method according to claim 1, further comprising the steps of:
k. uploading at least a portion of said hybrid edited video version of said video work to a video file sharing service; and,
l. viewing by the user said hybrid edited video work via said video file sharing service.

5. A method of hybrid video editing, wherein is provided a client computing device containing a video work, and a server remote from the client computing device, comprising the steps of:
a. accessing the server from the client computing device;
b. determining a processing power of said client computing device;
c. selecting by a user the video work;
d. creating within said client computing device a low resolution version of at least a portion of said video work;
e. transmitting the low resolution version of said at least a portion of said video work from the client computing device to the server;
f. transmitting the video work from the client computing device to the server;
g. using said client computing device to select a video editing operation;
h. using said determined processing power of said client computing device and said selected video editing operation to determine whether to perform said video editing operation on said client computing device or on said server;
i. if said determination is made to perform said video editing operation on said client computing device,
(i1) performing said selected video editing operation on said client computing device,
(i2) transmitting indicia representative of said selected video editing operation from said client computing device to said server
(i3) on said server, performing said selected video editing operation on said video work, thereby creating an edited video work;
j. if said determination is made to perform said video editing operation on said server,
(j1) on said server performing said selected video editing operation on said low resolution version of said video work, thereby creating an edited low resolution video work;
(j2) on said server performing said selected video editing operation on said video work, thereby creating an edited video work;
(j3) transmitting at least a portion of said edited low resolution video work to said client computing device for display to the user;
k. performing steps (g) through (j) at least twice, thereby creating a hybrid video edit of said video work.

6. The method according to claim 5, wherein said video editing operation is selected from the group consisting of a transition, a video cut, an insertion of a still photo into said video work, an insertion of a second video work into said video work, and, a color correction of said video work.

7. hod according to claim 5, further comprising the step of:
l. displaying within said browser at least a portion of said hybrid video edit of said client video work on said client device.

8. The method according to claim 5, further comprising the steps of:
l. uploading at least a portion of said hybrid video edit of said video work to a video file sharing service; and,
m. viewing by the user said uploaded hybrid video edit work of said video work via said video file sharing service.

9. A method of hybrid video editing, wherein is provided a client computing device containing a video work, and a server remote from the client computing device, comprising the steps of:
a. accessing the server from the client computing device using an Internet browser;
b. requiring a user to select the video work;
c. determining a processing power of said client computing device;
d. creating a low resolution version of at least a portion of said video work;
e. transmitting the low resolution version of said at least a portion of said video work from the client computing device to the server;
f. transmitting the video work from the client device to the server in background;
g. requiring the user to select a video editing operation while said video work is being transmitted to the server;
h. using said processing power of said client computing device and said selected video editing operation to determine whether to perform said video editing operation on said client computing device or on said server;
i. if said determination is made to perform said video editing operation on said client computing device,
(i2) on said client computing device performing said video editing operation, thereby creating an edited low resolution video work,
(i2) transmitting from said client computing device to said server an indicium representative of said selected video editing operation;
j. if said determination is made to perform said video editing operation on said server, performing said video editing operation on said low resolution version of said video work, thereby creating an edited low resolution video work;
k. displaying within said browser at least a portion of said edited low resolution video work;
l. performing steps (c) through (k) at least twice, thereby sending at least two indicia representative of at least two selected video editing operations to said server;
m. using said transmitted at least two indicia representative of said at least two editing operations to perform on the server said at least two editing operations on said low resolution video and said video work, thereby producing an edited low resolution video work and a hybrid edited video work; and,
n. displaying on said client computing device at least a portion of said edited low resolution video work.

10. The method according to claim 9, wherein said video editing operation is selected from the group consisting of a transition, a video cut, an insertion of a still photo into said video work, an insertion of a second video work into said video work, and, a color correction of said video work.

11. The method according to claim 9, further comprising the steps of:
o. uploading at least a portion of said hybrid edited video work to a video file sharing service; and,
p. viewing by the user said uploaded hybrid edited video work of said video work via said video file sharing service.
